(19) United States
(12) Patent Application Publication
(10) Pub. No.: US 2008/0204772 A1
(43) Pub. Date: Aug. 28, 2008

(54) METHOD AND APPARATUS FOR PROCESSING A PRINT ORDER

(76) Inventor: David S. Kauffman, Vancouver (CA)

Correspondence Address: David A. Novais, Patent Legal Staff;Eastman Kodak Company, 343 State Street, Rochester, NY, 14650-2201, US

(21) Appl. No.: 11/678,276

(22) Filed: Feb. 23, 2007

(51) Int. Cl. H04N 1/00

(52) U.S. Cl. 358/1.9

(57) ABSTRACT

A printing system allows a print buyer to submit an electronic print order. The system analyzes the print order to determine whether a print configuration dictated by the print order can accurately reproduce all of the colors of the associated printing content. The system provides the print buyer with information to determine whether a different print configuration that improves color accuracy has an acceptable production impact for the print order.

### CROSS REFERENCE TO RELATED APPLICATION

Reference is made to commonly-assigned copending U.S. patent application Ser. No. ______ (attorney docket 93463), filed ______, entitled PRINT PRICING, by Afshin Mirmotahari et al., the disclosure of which is incorporated herein.

### FIELD OF THE INVENTION

This invention pertains to a method for printing an electronically received print order. The invention further pertains to a method for printing in which prior to finalizing the print order, the print order is compared with printing system capabilities to discover if the there are potential configurations of equipment that could produce a closer representation of the print intent that standard configurations would allow. Alternative printing options can be presented to the print buyer for selection along with potential impacts on the print production process.

### BACKGROUND OF THE INVENTION

Electronic submission of print orders is known in the art, with printing firms providing portals for submission of printing content and printing intent so that the print order can be printed with minimal interaction between the print buyer and the printing firm. Printing of business cards, forms, flyers and the like are examples of content that is well suited to this method of print buying. The printing firm can specify the printing intent options available to the print buyer for a print product type (e.g. business card). Electronic submission of the print buyer's intent helps keep the cost of production low since customer service labor is minimized. Eastman Kodak's Insite product is an example of a portal system that provides electronic submission of print orders.

It is common for printable content to be specified using an RGB color space such as sRGB or Adobe® RGB. RGB color spaces are common because printable content is usually created using a computer with a color monitor that produces color consistent with these color spaces. In addition, RGB color spaces are generally considered to have large color gamuts so that a large range of colors can be specified.

Unfortunately for printing firms, supplied content may specify colors that cannot be easily reproduced using some print configurations. For example, when specifying the printing intent for a particular product type the default printing intent may be to use standard printing devices configured to print with a standard paper stock and a standard set of printing inks. This may simplify the production process and help reduce the printing price. Standard printing inks could, for example, include CMYK (cyan, magenta, yellow and black) inks of a particular formulation. Standard paper stock could, for example, include stock with particular ink absorption and spectral properties. Standard printing devices, for example could have imaging characteristics that are inferior to other printing devices available at the printing firm.

For many print orders, the standard print configuration is adequate and the print buyer will likely be satisfied with the default configuration. However, if the content includes colors outside the color gamut of the standard print configuration, the print buyer may be dissatisfied with the printed result. For example, a printing firm may automatically convert the colors specified in the content to a close approximation of the color achievable by the selected print configuration (e.g. gamut mapping). When the print buyer receives his/her order, the color approximation may not be satisfactory but the printing firm will have already incurred the costs and it may be too late to reprint the material to satisfy the print buyer.

Some printing portal vendors, partially address this situation by providing a soft proof of the print order on the print buyer's computer display. If the computer display is accurately calibrated, the expected printed colors will be presented on the display and the print buyer will have the option to accept or reject the proposed approximation of the original content. However, the print buyer may not have a properly calibrated display or he/she may not notice an unacceptable color approximation in the soft proof.

Some vendors have partially addressed this problem by comparing the color gamut of the printable content with the color gamut of the selected print configuration to identify areas of the content that may be subject to color approximation. For example, U.S. Pat. No. 6,707,931 teaches providing indicia on a display of the content corresponding to parts of the content that are outside the gamut of the printer. However, knowing that there is a problem does not allow the print buyer to immediately identify a remedy and proceed with the print order.

Other vendors have partially addressed this problem by automatically selecting a printing device that can reproduce the color gamut of the printable content. For example, U.S. Pat. No. 6,549,654 teaches automatically selecting an optimum output device by comparing the color gamut of the printable content with the color gamut of available printing devices. As another example, US patent application No. 2002/0149786 teaches automatically identifying the most suitable printing device based on a color gamut comparison, and further teaches allowing the print buyer to specify the method in which colors are mapped from the content color space into the printing device color space. For example, application 2002/0149786 teaches that different rendering intents can be specified to govern how colors are mapped. However, automatically selecting an alternate printer or allowing the print buyer to configure the color mapping method may not provide the print buyer with the information and flexibility to make the correct tradeoff between color accuracy and other factors for the print order.

A need exists for a print buyer to be able to identify a potential color matching problem for a print order and be automatically presented with information to mitigate the problem to enable, for example, a determination of the correct tradeoff between color accuracy and other factors for the print order.

### SUMMARY OF THE INVENTION

The present invention provides a print buyer with information about color reproduction accuracy of a configurable print device for an electronically received print order, and allows the print buyer to make an informed choice for finalizing the print order.

According to one aspect of the invention, a printing system portal allows a print buyer to submit a print order including printing intent and printing content. The printing system evaluates the printing content in view of the printing intent to determine whether the content specifies colors which cannot be accurately reproduced based on a print configuration dictated by the printing intent. If the print configuration cannot accurately reproduce all of the colors from the content, the print buyer is informed of the discrepancy and provided with information to enable the print buyer to decide how to proceed with the order.

According to one aspect of the invention, the information can include an indication of the colors from the content that cannot be accurately reproduced. According to another aspect of the invention, the information can include printing intent options that will mitigate the color reproduction accuracy. According to another aspect of the invention, the information can include production impacts associated with selecting an option.

A variety of methods can be employed to convey the information. An exemplary list of methods includes:
1. Providing information about the currently selected printing intent and its production characteristics, including at least one of color reproduction accuracy, price and production schedule.
2. Providing information about specific colors from the content which cannot be accurately reproduced by the selected printing intent.
3. Providing a comparison of a desired color and an expected color that will be reproduced by the selected printing intent.
4. Providing a soft proof display of the content using the colors that are expected to be reproduced for the selected printing intent.
5. Providing one or more color accuracy mitigating options, which when selected will update other displayable information. Exemplary options can include: adding an additional ink color, using a different paper stock, using a different printer type, using an alternate imaging mode, and using an alternate ink formulation.

According to another aspect of the invention, the print buyer can specify portions of the content that should be included in the color reproduction accuracy evaluation.

### BRIEF DESCRIPTION OF THE DRAWINGS

FIG. 1 is a system block diagram according to one embodiment of the present invention;

FIGS. 2A-2B are illustrations of exemplary printing content and printing intent for a print order according to one embodiment of the invention;

FIG. 3 is an illustration of a projection of an exemplary RGB color gamut on the chromaticity plane of the CIELAB color space;

FIGS. 4A-4D are illustrations of projections of exemplary print configuration gamuts on the chromaticity plane of the CIELAB color space;

FIG. 5 is an illustration of color coordinates for exemplary printing content in relation to color gamut projections; and

FIG. 6 is an illustration of exemplary order information provided to a print buyer according to one embodiment of the invention.

### DETAILED DESCRIPTION OF THE INVENTION

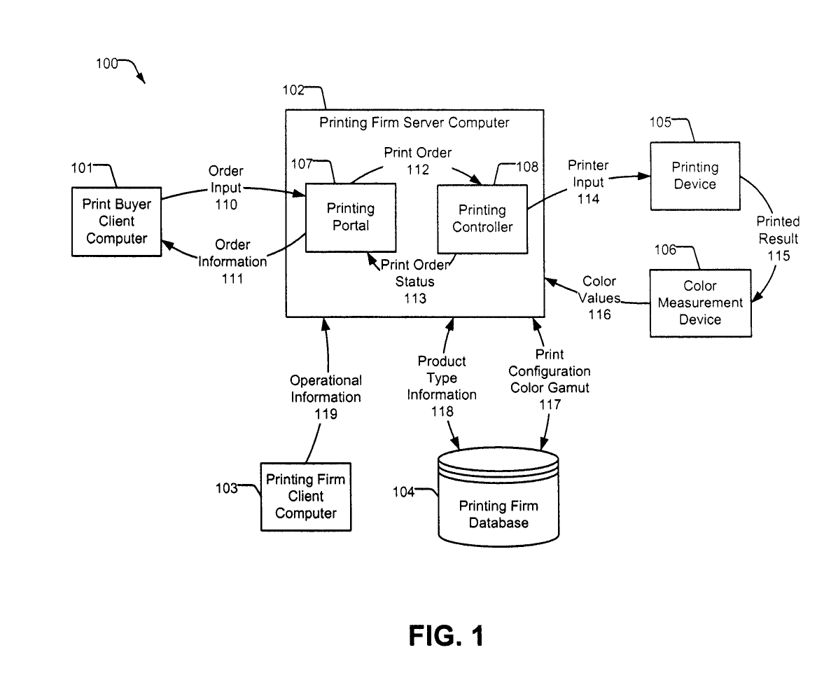

FIG. 1 is a system block diagram according to one embodiment of the present invention. Printing system 100 is provided, at least in part, by a printing firm to allow a print buyer to procure printed material from a printing firm by submitting an electronic print order 112 from a client computer 101. The print buyer creates electronic print order 112 by supplying order input 110 including, for example, information about printing intent and printing content. The print buyer can receive order information 111 including, for example, information about orderable product types, prompts, previews and progress information. System 100 can be configured to support a variety of printed product types such as business cards, forms, flyers and the like. For a given product type, the printing firm can configure product type information 118 including a number of printing intent parameters whose values are to be supplied by a print buyer. A printing intent parameter can be configured to allow a print buyer to pick from a number of predefined values or can allow the print buyer to supply free-form information (e.g. quantity). Certain parameters (e.g. printing colors) can be configured to be optional and have corresponding default values (e.g. CMYK). Optional parameters and their default values may or may not be presented to the user depending on product type configuration.

System 100 also includes equipment at the printing firm's site, including at least one of each of server computer 102, client computer 103, database 104, printing device 105 and color measurement device 106. Multiple occurrences of a piece of equipment can be configured to share processing load or provide continued operation in the event of equipment failure. Equipment of system 100 can be configured to communicate via various means including dedicated connections, network communication services, and wireless communication links as examples.

Client computers 101 and 103 can be of similar or different types and can include color calibration capabilities including color measurement devices (not shown) to improve color reproduction accuracy. Client computer 101 provides an environment to operate a web browser or a specialized application, for example, for communicating with server computer 102 about print orders 112. Client computer 103 provides an environment to operate a web browser or specialized application, for example, for communicating operational information 119 with server 102. Operational information 119 can include, for example, information related to the configuration of and/or the operation of system 100.

Server computer 102 provides an environment to operate printing portal 107 and printing controller 108. Printing portal 107 can include one or more specialized applications to enable a print buyer to communicate about print orders 112 being processed by system 100. Printing portal 107 submits print order 112 to printing controller 108 and receives print order status 113 which can be communicated back to the print buyer. Printing controller 108 can include one or more specialized applications to provide printing workflow (e.g. prepress operations and printing device 105 load management). Other print production software applications (not shown) for supporting other aspects of print production (e.g. finishing, billing, delivery) can also operate on server computer 102 or other computers in communication with server computer 102.

Printing device 105 can be, for example, a Computer-To-Plate (CTP) device for producing printing media for printing presses such as an offset or flexographic press. As another example, printing device 105 can be a digital printing device employing xerographic, inkjet or other types of direct imaging capabilities. Typically, a printing firm will maintain a variety of printing devices 105 of different types and capacities to provide flexible production capacity.

Printing firms are keen to provide cost and service differentiation due to intense competition. This motivates them to provide simple low-cost printing with fast turnaround as well as higher quality options for those that demand them albeit at the best possible price. To support this need, the present invention includes a database 104 which can include, among other things, information that characterizes the color and other capabilities of printing devices 105. This can be accomplished, for example, by periodically measuring a printed result 115 produced by each printing device 105 from printer input 114 (e.g. raster image data) for a range of print configurations (e.g. type of ink, number of inks, type of paper, imaging mode), since each configuration may enable a different printable gamut. Color measurement device 106 (e.g. a spectrophotomer) is an example of one such device that can be used to measure color values 116 corresponding to elements of printer input 114. As one alternative, a set of color reproduction standards can be established and measurement device 106 can be used to calibrate printing device 105 so that it meets a standard.

Regardless of the approach, database 104 can maintain a set of print configuration color gamuts 117 based on measurements made by color measurement device 106. A color gamut 117 characterizes the range of colors that printing device 105 can reproduce for a specific print configuration. Color gamut 117 can be represented as an N-dimensional color space volume corresponding to the set of color values that can be reproduced. The 3-dimensional CIELAB color space provides a device-independent coordinate system that is currently popular for characterizing color gamuts among a wide variety of printing and display devices. The CIELAB color space characterizes color in terms of lightness (“L*” parameter) and chromaticity (“a*” and “b*” parameters). Zero values for chromaticity parameters correspond to neutral colors (e.g. grey) with varying lightness parameter values corresponding to shades of gray (e.g. from black to white). Extreme values for individual chromaticity parameters correspond to user perception of highly saturated colors.

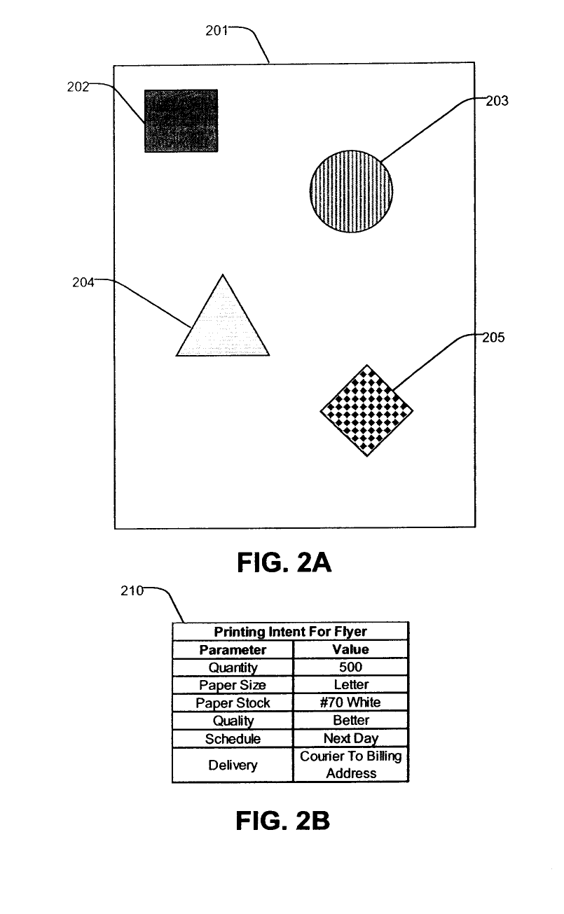

FIG. 2A is an illustration of exemplary printing content 201 identified by order input 110. It corresponds to a description for an image to be printed by printing device 105. As an example, printing content 201 can be specified as a raster image or as part of page description language (e.g. Adobe® PDF). Printing content 201 includes four content elements 202-205. Rectangle 202 is configured to paint with a grey fill color. Circle 203 is configured to paint with an orange vertical fill pattern. Triangle 204 is configured to paint with a green horizontal fill pattern. Diamond 205 is configured to paint with a blue checkerboard fill pattern. Element colors can be configured as coordinates in a color space. For example, elements 202-205 can be configured to paint their respective colors in the sRGB color space using a combination of primary additive colors: red, green and blue. Other color spaces can be used as dictated by the originator of printing content 201. Identifying the color space can usually be determined by reading a tag included in printing content 201. Alternatively, the color space can be communicated separately or be inferred by examining the color coordinates specified by elements 202-205. In printing content 201, assume that elements 202-205 have color configured in an RGB color space.

FIG. 2B is an illustration of exemplary printing intent 210 for a flyer product type identified by order input 110. Printing intent 210 includes a set of parameter name and value pairs. As described above, parameter names and the range of allowable values can be configured for the flyer product type as part of product type information 118. For printing intent 210, note that no color parameter name and value is provided by the print buyer as part of the initial electronic order. This may mean that there are no printing color options available. As one alternative, this may mean that there are default printing colors, perhaps predetermined for this product type or perhaps determined based on the printing device 105 to be selected for printing. For the flyer product type, assume that a default print configuration is associated with the flyer product type and it includes the use of only the CMYK subtractive primary colorants. Print configurations can also be dynamically determined based on business rules that evaluate printing intent 210 (e.g. quality parameter) in relation to print configurations characterized in database 104.

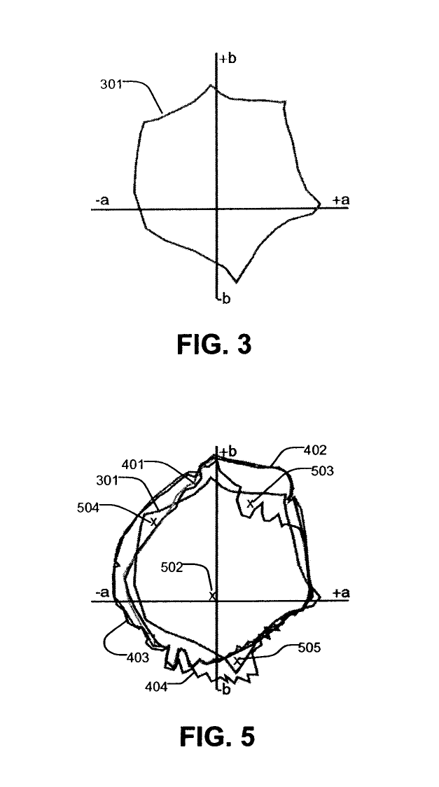

FIG. 3 is an illustration of a projection 301 of an exemplary RGB gamut for printing content 201 on the chromaticity plane of the CIELAB color space. The area of projection 301 corresponds to the range of possible chromaticity coordinates reproducible by a device for a given value of lightness. At different values of lightness, projection 301 will have a different shape corresponding to the locus of the device's color gamut volume at that lightness. Gamut volume and corresponding projections 301 may be derived from industry standard information or may be derived from a series of measured color values. For clarity, the remainder of the invention will be described in terms of gamut projections corresponding to one value of lightness. It will be understood that the invention is equally applicable to color values corresponding to the full gamut of the devices.

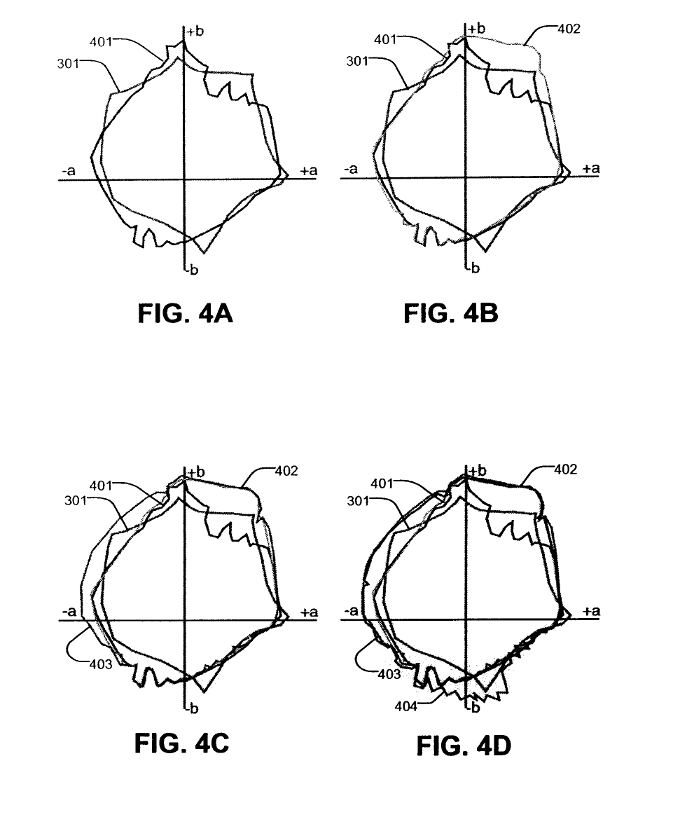

FIGS. 4A-4D are illustrations of projections 401-404 of exemplary print configuration gamuts on the chromaticity plane of the CIELAB color space. Projection 401 corresponds to a range of chromaticity coordinates reproducible by a print configuration including only CMYK colorants. Note that there are many chromaticity coordinates that are reproducible by both RGB projection 301 and CMYK projection 401. However, there are chromaticity coordinates not reproducible by CMYK projection 401 that are reproducible by RGB projection 301 (e.g. the areas inside projection 301 but outside projection 401).

FIG. 4B depicts adding an orange colorant to the print configuration to achieve a CMYKO projection 402 that enables printing device 105 to reproduce a broader range of orange colors corresponding to the upper, right hand area of the chromaticity plane. FIG. 4C depicts adding a green colorant to the print configuration to achieve a CMYKOG projection 403 that enables device 105 to reproduce a broader range of green colors corresponding to the left hand area of the chromaticity plane. FIG. 4D depicts adding a blue colorant to the print configuration to achieve a CMYKOGB projection 404 that enables device 105 to reproduce a broader range of blue colors corresponding to the lower area of the chromaticity plane.

One can see that by adding selected colorants, the gamut of printing device 105 can be extended and in some cases exceed the RGB gamut associated with printing content 201. However, adding each colorant may increase the cost of raw materials (e.g. additional printing plates and inks) and may increase production time (imaging rendering and imaging time and printing device make-ready time). Depending on the nature of the image and the print buyer's priorities, it may or may not be necessary or desirable to modify the default print configuration. Other print configuration changes, besides adding printing colors, can be used to improve a printing device color gamut. For example, using a different type of printing device 105, different CMYK ink formulations, printing stock or imaging modes (e.g. resolution or screening methods) may produce different printing gamuts.

FIG. 5 is an illustration of color coordinates for exemplary printing content 201 in relation to projections 301 and 401-402. Color coordinate 502 corresponds to the grey fill color for rectangle 202. Color coordinate 503 corresponds to the orange fill color for circle 203. Color coordinate 504 corresponds to the green fill color of triangle 204. Color coordinate 505 corresponds to the blue fill color of diamond 205. One can see that each color coordinate 502-505 exists within RGB projection 301 as expected. However only color coordinate 502 exists within CMYK projection 401. Thus, printing device 105 with the default print configuration would only be able to accurately reproduce the color of rectangle 202.

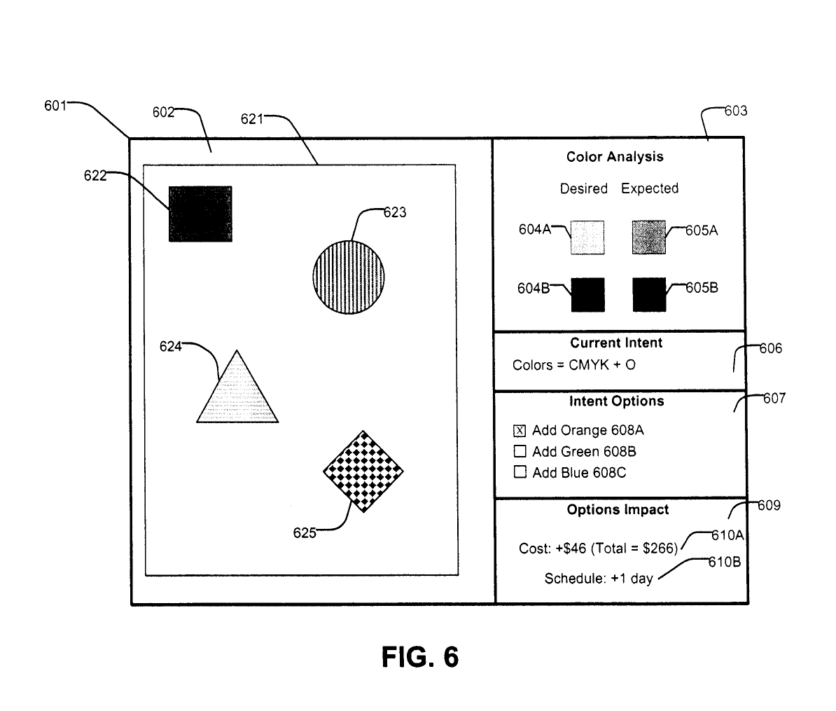

FIG. 6 is an illustration of exemplary order information 111 displayed to a print buyer for order input 110 according to one embodiment of the invention. Information display 601 can be presented to the print buyer on the display of client computer 101 after receiving order input 110. The print buyer can approve the print order 112 or allow optional printing intent to be considered. Display 601 can include a content preview pane 602. Pane 602 can include one or more preview images 621. Preview image 621 can, as shown, be a soft proof of an expected printed result 115 of printing content 201. Preview image elements 622-625 correspond to elements 202-205 and are reproduced on the print buyer's display with expected colors for a selected print configuration. Preview image 621 can be dynamically refreshed with new preview information. For example, the print buyer may choose to zoom and or pan to focus attention on one part of preview image 621. As another example, if changes in printing intent 210 are made, the expected colors can be refreshed.

According to one embodiment of the invention, information display 601 includes a color analysis pane 603. Color analysis pane 603 presents information based on comparing the desired colors specified by printing intent 210 to print configuration color gamut 117 dictated by a selected printing intent 210. In particular, pane 603 can include the results of a set of color comparisons. As one example, pane 603 can present desired colors from printing content 201 colors that are out of gamut for a selected (e.g. current) print configuration. Server computer 102 can determine colors that are out of gamut for a print configuration, for example, by examining each color specified in printing content 201. Each color can be converted to coordinates in a CIELAB color space, for example, and then those coordinates can be determined as in or out of gamut for print configuration color gamut 117.

According to one embodiment, the print buyer can specify parts of printing content 201 whose colors should be included or excluded from a comparison with print configuration color gamut 117. As an example, the print buyer can select areas of preview image 621 using a mouse. As another example, the print buyer can select elements by characteristics (e.g. type or location) derived from printing content 201.

According to one embodiment, color analysis pane 603 depicts sets of color swatches in proximity to allow visual comparison between desired color and out-of-gamut expected color. For example, pane 603 depicts desired color swatches, 604A and 604B corresponding to the desired color of elements 204 and 205, which cannot be accurately reproduced by the current print configuration. Display 603 also depicts expected color swatches 605A and 605B nearby desired color swatches 604A and 604B respectively. Swatches 605A and 605B correspond to the expected color of elements 204 and 205 respectively, and are approximations of the out-of-gamut desired colors. Presentation of the out-of-gamut expected colors can simplify the print buyer's evaluation of preview image 621 by limiting the information to evaluate. A nearby comparison of desired and out-of-gamut expected color swatches can simplify the print buyer's task of determining whether the expected color is close enough to the desired color. Other comparisons, such as between expected colors for different printing intents, can also be provided in some embodiments.

According to one embodiment, system 100 can allow the print buyer to select one of the out of gamut colors (e.g. by a mouse click) and have preview image 621 automatically refresh to provide the appropriate zoom and pan settings to provide a contextual comparison of the expected color. If more than one occurrence of an out-of-gamut color exists in printing content 201, repeated selection of the color can cause preview image 621 to refresh according to a next non-adjacent image location within preview image 621 configured with the selected color.

According to one embodiment, system 100 can allow the print buyer to request that out-of-gamut expected colors are included in pane 603 only if their color coordinates differ from the desired color coordinates by a pre-determined amount. For example, a delta-E threshold can be established which describes the distance between desired and expected color values in CIELAB color space. In addition, pane 603 can present a comparison of color coordinate values (e.g. a delta-E value) in relation to or in place of color swatches 604 and 605. The latter may be beneficial for customers having uncalibrated displays or otherwise not wanting to rely on visual analysis.

According to one embodiment, the system 100 can provide a current printing intent pane 606 and a printing intent options pane 607. Current printing intent pane 606, for example, can include information about current printing intent parameters that affect color. Pane 606 can include, for example, buttons (not shown) or other means to finalize the print order 112 based on the current printing intent 210.

As depicted in FIG. 6, the print buyer has already selected addition of the orange colorant relative to the original printing intent 210. Server computer 102 can determine and present printing intent options that may improve color accuracy. For example, printing intent options 608 can be selected by the print buyer to preview the effects of using additional colorants. Display 601 can be refreshed accordingly when one or more of the options are selected. For clarity, other exemplary options discussed above, are not illustrated but could be presented in display 601.

As part of presenting a refreshed display 601A, 610B, server computer 102 can calculate a production impact 610 to the print production process and present it to the print buyer in option impact pane 609. For example, a cost impact 610A and a schedule impact 610B, relative to a specified (e.g. default or previously current) printing intent 210 can be calculated based on business rules and presented to the print buyer. Thus, a print buyer can easily consider the effect of changing printing intent in a convenient manner. Selection of an appropriate tradeoff between color accuracy, cost, time or other factors can be easily made.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the spirit and scope of the invention.

1. An automated method for processing a print order, the method comprising:
receiving an electronic print order from a print buyer, wherein the print order identifies a printing intent and a printing content of the print order;
identifying a first print configuration for printing based on the print order;
identifying a desired color from the printing content that cannot be accurately reproduced by the first print configuration;
identifying a second print configuration that can more accurately reproduce the desired color;
presenting the print buyer with a production impact associated with the identified second print configuration; and
submitting the print order with a modified printing intent corresponding to the identified second print configuration if the print buyer accepts the production impact.

2. A method according to claim 1, wherein identifying the desired color from the printing content that cannot be accurately reproduced by the first print configuration comprises identifying the desired color by analyzing colors from the printing content based on a color gamut of the first print configuration.

3. A method according to claim 2, wherein identifying the desired color by analyzing colors from the printing content includes identifying an expected color corresponding to the desired color based on the color gamut of the first print configuration.

4. A method according to claim 3, wherein identifying the desired color is based on a degree of difference between the expected color and the desired color.

5. A method according to claim 1, wherein identifying the second print configuration includes identifying an additional colorant to be used in printing.

6. A method according to claim 1, wherein identifying the second print configuration includes identifying an alternate ink formulation to be used in printing.

7. A method according to claim 1, wherein identifying the second print configuration includes identifying a different paper stock to be used in printing.

8. A method according to claim 1, wherein identifying the second print configuration includes identifying a different type of printer to be used in printing.

9. A method according to claim 1, wherein identifying the second print configuration includes identifying a different imaging mode to be used in printing.

10. A method according to claim 1, wherein presenting the print buyer with a production impact associated with the second print configuration comprises presenting a price impact.

11. A method according to claim 1, wherein presenting the print buyer with a production impact associated with the second print configuration comprises presenting a schedule impact.

12. A method according to claim 1, wherein the print buyer identifies an area of the printing content to be included when analyzing the printing content.

13. A method according to claim 1, wherein the print buyer identifies an area of the printing content to be excluded when analyzing the printing content.

14. A method according to claim 1, including providing the print buyer with information about a first and a second color, both associated with a desired color from the printing content.

15. A method according to claim 14, wherein the first color is the desired color from the printing content and the second color is an expected color based on an identified print configuration.

16. A method according to claim 14, wherein the first and second colors are expected colors for a first and second print configuration.

17. A method according to claim 14, wherein providing the print buyer with information about the first and second colors associated with the desired color from the printing content comprises providing a visual comparison of the first and second colors.

18. A method according to claim 14, wherein providing the print buyer with information about the first and second colors associated with the desired color from the printing content comprises providing the results of a comparison of color coordinates for the first and second colors.

19. A method according to claim 1, including a preview image of the printing content, wherein the preview image includes expected colors for the printing content based on an identified print configuration.

20. An apparatus for processing a print order, the apparatus comprising:
a database operative to:
store information about a plurality of product types and a plurality of print configurations;
a server computer operative to:
receive order input from a client computer including information about an electronic print order, wherein the print order identifies a printing intent and a printing content;
identify a first print configuration for printing based on the print order;
identify a desired color from the printing content that cannot be accurately reproduced by the first print configuration;
identify a second print configuration that can more accurately reproduce the color;
present the client computer with order information including at least one of the first and second print configurations, the desired color that cannot be accurately reproduced by the first print configuration and a production impact associated with the second print configuration;
submit the print order with a modified printing intent corresponding to the second print configuration if the client computer accepts the production impact;
submit the print order corresponding to the first print configuration if the client computer rejects the production impact; and
control the production of printed material based on the print order and the product type information obtained from the database; and
a client computer operative to perform one or more of the following:
provide operational information to the server computer; and
receive order information from the server.
